(19) United States
(12) Patent Application Publication
(10) Pub. No.: US 2004/0117490 A1
(43) Pub. Date: Jun. 17, 2004

(54) Method and system for providing chaining of rules in a digital rights management system

(75) Inventors: Petr Peterka, San Diego, CA (US); Jiang Zhang, San Diego, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: General Instrument Corporation, Horsham, PA

(21) Appl. No.: 10/318,590

(22) Filed: Dec. 13, 2002

(51) Int. Cl. G06F 15/16

(52) U.S. Cl. 709/229

(57) ABSTRACT

A system for determining whether a client is authorized to access content in a communication network is disclosed. The system includes a computer software product containing programming instructions for defining content access rules in connection with accessing the content and for identifying client selections related to the content. The computer software product further includes programming instructions for providing client entitlement data. The computer software product further includes programming instructions for comparing the client entitlement data with the content access rules and the client selections to determine whether the client is authorized to access the content. Optionally, the computer software product also includes programming instructions that allow additional rules to be added to the content access rules. These additional rules can be added by other parties that are involved in the process of providing the requested content to the client.

### CROSS-REFERENCES TO RELATED APPLICATION

The present application is related to U.S. patent application Ser. No. 10/125,294 entitled “DIGITAL RIGHTS MANAGEMENT SYSTEM FOR CLIENTS WITH LOW LEVEL SECURITY” filed on Apr. 17, 2002, the disclosure of which is hereby incorporated by reference in its entirety for all purposes.

### BACKGROUND OF THE INVENTION

The present invention relates generally to the field of communication systems, and more specifically to a system for managing digital rights.

Electronic communication networks such as the Internet have created an increased demand for digital content. Along with this demand comes the need to manage digital rights associated with millions of users. Digital rights management is used to provide content only to authorized entities in a communication network.

As an example, in cable access systems, digital rights management ensures that MPEG streams are received only by authorized set-top boxes. In such cable access systems, digital rights are typically enforced at the set-top box since such hardware devices are relatively more secure vis-a-vis software based devices. Various types of rights management messages are sent to the set-top box where they are evaluated. One type of message known as an entitlement management message (EMM) is used for conveying access privileges belonging to a particular subscriber. Another type of message known as an entitlement control message (ECM) is used to specify access rules for the content stream and convey cryptographic information for computing cryptographic keys. After the EMM and ECM are received, the client evaluates the messages to determine if the set-top box is authorized to receive the MPEG stream. If authorized, the set-top box is allowed to access the MPEG stream.

Disadvantageously, this cable digital rights management system is unsuitable for computing networks because many such networks have software-based clients with a low trust level. An IP network is an example of such a network. Applying the EMM/ECM approach to an IP network, for example, may likely result in loss of content due to content piracy.

Moreover, there is no flexibility in the EMM/ECM approach. For example, digital rights management language for expressing EMM/ECM messages cannot be extended to suit different network architectural models. This language is specifically designed to express content access rules that are enforced at the end user device.

Hence, it would be desirable to provide a system that is capable of facilitating management of digital rights in a more efficient manner.

### BRIEF SUMMARY OF THE INVENTION

In one exemplary embodiment of the present invention, a digital rights management system is provided for determining whether clients are authorized to access content within a communication network. In one exemplary implementation, the client is software based. However, the client may be hardware based, or may be a combination of software and hardware.

The client, wishing to access content, initially registers at a provisioning center and a key distribution center. Subsequently, the client may request content at any time upon providing the requisite registration information. When content is requested, digital rights management objects are delivered to a location remote from the client. At this remote location, the rights management objects are evaluated to determine whether the client is authorized to access content. Advantageously, by using remote evaluation, the present invention shifts evaluation tasks away from clients, particularly software-based clients that are vulnerable to cryptographic attacks. After remote evaluation is completed, and if the client is authorized, the content is securely delivered from the content provider (or a caching server) to the client.

According to a first exemplary aspect, the system comprises a computer software product containing programming instructions that define content access rules or content rights in connection with providing access to the content. Content access rules are content specific and are independent of the client. An example is a blackout rule where access to content is restricted to certain geographical locations. Another example of a content access rule is a list of subscription services to which the content belongs. In one exemplary embodiment, the content access rules are defined in a session rights object. Upon receiving a content request, the content provider forwards this session rights object to the client.

The computer software product includes programming instructions for identifying client selections such as payment options selected to pay for the content. A payment option may be pay-per-view, for example. Or, it may be pay-by-time, subscription, etc. By separating client selections and the generic rules, the present invention permits enforcement to occur at a location remote from the client. Remote evaluation is particularly advantageous to software based clients, although it is applicable to hardware based clients as well. In one exemplary embodiment, client selections may be included in the session rights object along with the content access rules for delivery to the remote location. Alternatively, the rules and client selections may be delivered separately to the remote location for evaluation.

The computer software product further includes programming instructions for providing authorization data for defining the client's entitlements. An entitlement is client information that is used to evaluate the client's right to content. It may include subscribed services, geographical location, client payment method, and other relevant data that are specific to the client.

The authorization data, rules and client selections (e.g., payment options) are delivered to a location remote from the client. This location may be a caching server, for example, that is closest to the client. Alternatively, the information may be delivered to a third party system for evaluation. Upon evaluation, and if the authorization data matches the client selections information and the content access rules, the client is allowed to access the content.

Optionally, additional rules can be added to the content access rules. These additional rules can be added by other parties that are involved in the process of providing the requested content to the client.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1 is a simplified block diagram illustrating a digital rights management system in accordance with one exemplary embodiment of the present invention;

FIG. 2 is a screen shot illustrating a content rights element that defines generic rules for content access in accordance with one exemplary embodiment of the present invention;

FIG. 3 is a screen shot illustrating a client selections element for identifying selections made by a client in accordance with one exemplary embodiment of the present invention;

FIG. 4 is a screen shot illustrating an authorization data element for defining the client's entitlement in accordance with one exemplary embodiment of the present invention; and

FIG. 5 is a simplified diagram illustrating a digital rights management system in accordance with another exemplary embodiment of the present invention.

### DETAILED DESCRIPTION OF THE INVENTION

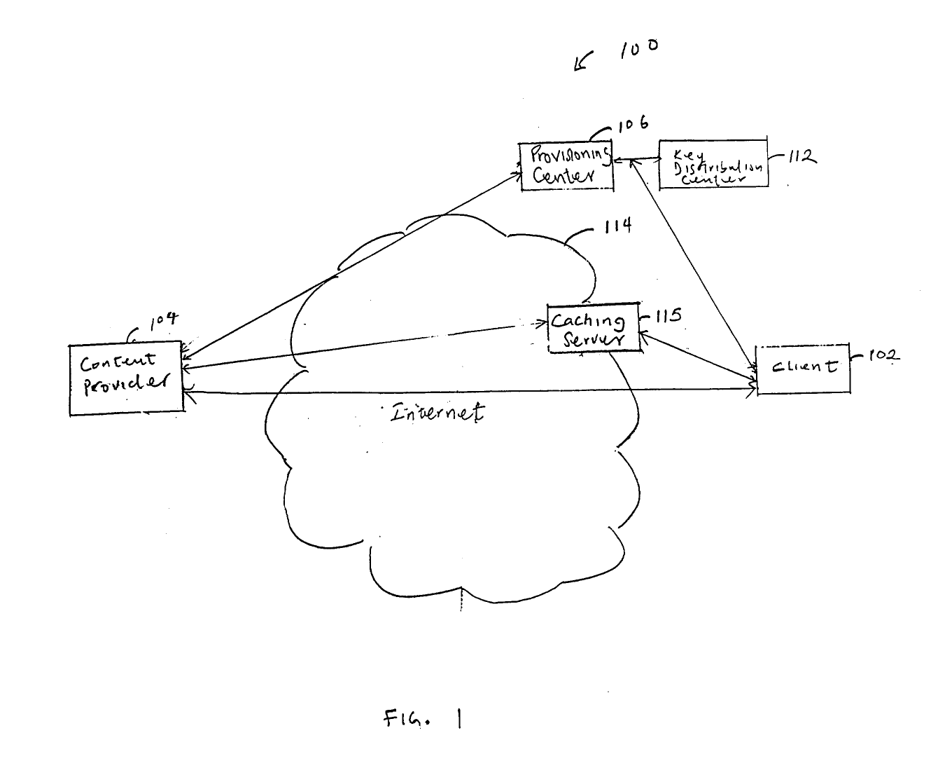

The present invention in the form of one or more exemplary embodiments will now be described. FIG. 1 is a simplified block diagram of an exemplary embodiment of a digital rights management system 100 in accordance with the present invention. The system 100 includes a content provider 104 for providing content and a computer network, such as, the Internet 114, through which the content is streamed. Further, the system 100 includes a key distribution center (KDC) 112 serving as a trusted third party arbitrator, a provisioning center 106, and at least one caching server 115 for streaming content to the client 102. Based on the disclosure and teaching provided herein, it should be understood that the functionality of the caching server 115 as described herein can be implemented on and performed by other types of servers including, for example, a streaming server or a content delivery server. As will be further discussed below, the system 100 is provided for determining whether a client 102 is authorized to access content provided by the content provider 104.

The system 100 operates in the following exemplary manner. The client 102, desiring content from the content provider 104, begins by registering at the provisioning center 106 and the KDC 112. This registration process securely establishes the identity of the client 102 such that the client's identity cannot be replicated. After registration, certain required information is furnished by the client 102 to the content provider 104. This information includes a list of one or more caching servers closest to the client 102; in this case, caching server 115. When the client 102 is authorized, the content is streamed from caching server 115 to the client 102. Other information optionally furnished to the content provider 104 includes a list of the client's subscribed services, the client's ability to pay for content, etc.

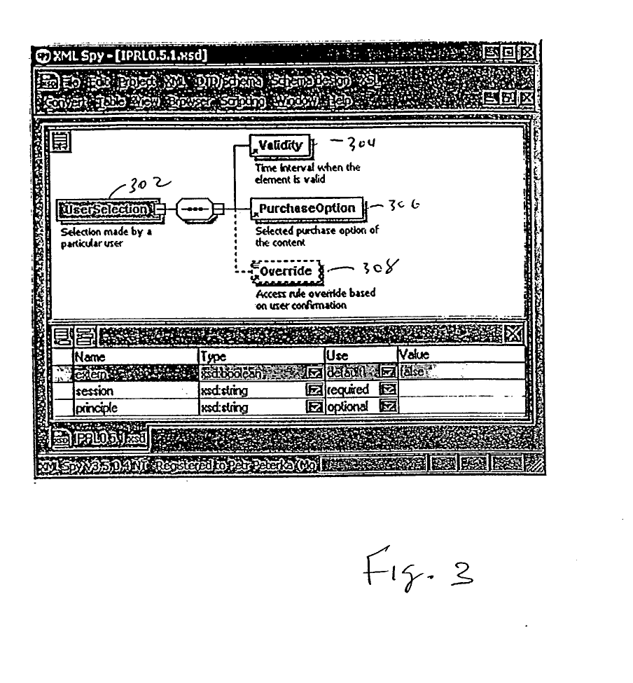

Thereafter, various purchase options are presented to the client 102 by the content provider 104. These purchase options indicate whether content is free, subscription only, pay-per-view, and so forth. In response, a desired purchase option is selected by the client 102. After a selection is made, a session rights object is provided to the client 102 by the content provider 104. The session rights object generally contains client selections, including the purchase option that has been selected by the client 102 for paying for the content. Another attribute of the client selections includes, for example, a time period for which the client selections element is valid. It should be understood that the client selections may contain other attributes as well. The client selections element is further described with reference to FIG. 3.

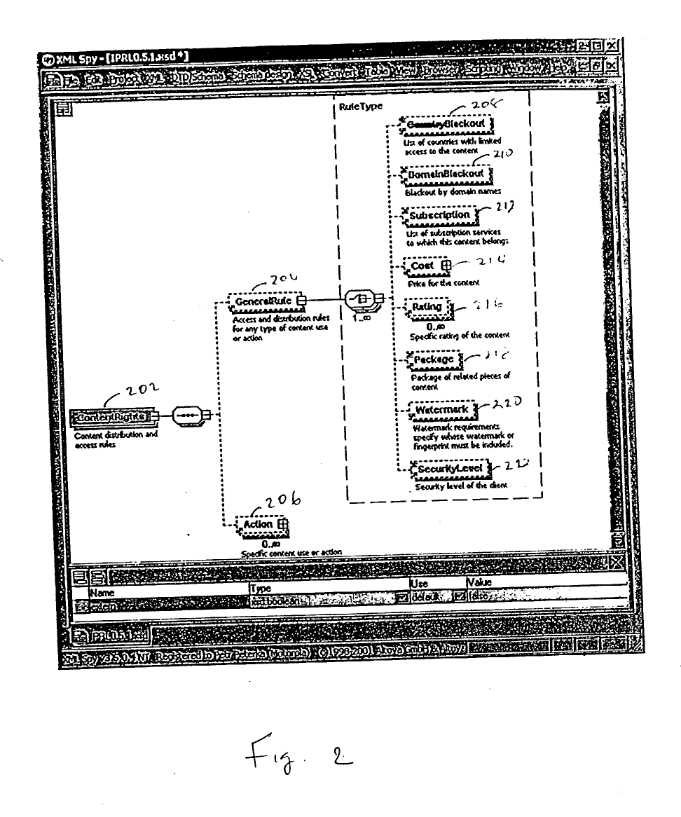

In addition to client selections, the session rights object may contain a content rights element. The content rights element includes content access rules that are to be used in connection with providing access to content. An example of such a content access rule may state that content cannot be accessed outside designated geographical locations. The content rights element is further described with reference to FIG. 2.

Upon generating the session rights object, the content provider 104 also forwards the relevant information relating to the client 102 and the desired purchase option to the provisioning center 106 and the KDC 112. The forwarded information is then used to generate a caching server ticket. The caching server ticket is to be retrieved by the client 102 to allow the client 102 to receive the desired content. The use of the caching server ticket will be further described below.

After the session rights object is received, the client 102 is redirected to caching server 115. At this point, the client 102 may already have obtained a caching server ticket from the KDC 112. The caching server ticket is an authentication token that includes authorization data indicating subscribed services, client payment method, etc. The caching server ticket may further include other types of information, such as, the client's identity, the server's name, a session key, etc. If the client 102 does not have the caching server ticket, then the client 102 contacts the KDC 112 to obtain such ticket.

The authorization data (from the ticket) and the session rights object are then presented by the client 102 to caching server 115. In this manner, the authorization data and the session rights object are evaluated remotely from the client 102. Remote evaluation is particularly advantageous where the client 102 is software-based and is vulnerable to cryptographic attacks. The caching server 115 compares the client selections and/or content access rules in the session rights object with authorization data from the caching server ticket. Information from the session rights object and the caching server ticket should match, since such information is originally generated by the content provider 104. If the information matches and is validated, that means the client 102 is authorized and content is allowed to be streamed to the client 102. On the other hand, if the information does not match, then that means the client 102 is not authorized and access to content is denied. In this manner, the system 100 is able to securely determine whether the client 102 is authorized to access content.

FIG. 2 is a screen shot illustrating the structure of the content rights element in accordance with one exemplary embodiment of the present invention. The content rights element defines content access rules to be used in connection with providing access to content. The content rights element also includes rules for billing and streaming as well. Rules for billing and streaming include cost and watermark rules, for example.

In one exemplary implementation, the content rights element is defined by using IPRL (Internet protocol rights management language) which itself is defined using XML (eXtensible mark-up language). IPRL provides a set of elements that may be grouped into three higher-level elements, namely, the content rights element, the client selections element and the authorization data element. All of these elements are employed for securely determining whether a client should be granted access to content.

As shown in FIG. 2, the content rights element 202 comprises an action element 206 and a general rules element 204. The general rules element 204 specifies rules associated with the use of the content regardless what action is performed. The action element 206 specifies a set of rules associated with a particular action or type of content use.

Optionally, a content identification element (not shown) is also provided. Content may be identified by different means, e.g., URI (universal resource identifier). Therefore, this element includes the type of identification and the identification itself. If type is not provided, URL (universal resource locator) may be used as the default identification type. This element may optionally include a string containing content name and/or description.

Action or Use

As mentioned above, in one exemplary embodiment, the content rights element 202 includes the action element 206. Content may be used in different ways, such as viewing a video, listening to music, printing a document, etc. Uses such as these are mostly controlled by the client 102 and are more applicable to trusted clients. The type of use that caching server 115 may control to some extent is streaming as opposed to download. The content provider 104 may limit content download to fully trusted clients while streaming may be allowed to clients with a lower level of security. The criterion would be the security level indicated in the authorization data.

General Rule/Access Rules or Access Limitations

The general rules element 204 generally includes access rules that specify the constraints associated with the different uses of content. Rules may be specified at the top level (at the content identification level) if they apply to all uses of the content. If certain rules are applicable to a specific use of the content, they may be listed within the action definition. As will be further described below, in one exemplary embodiment, the general rules element 204 further includes a number of constituent elements.

Blackouts

The blackout element 208, in general, restricts access to content to specific geographical or other types of regions. This access restriction may be inclusive (spot beam) or exclusive. Content distribution may be restricted to certain geographical areas. Such areas may be defined by country codes, ZIP or postal codes, latitude and longitude, XYZ coordinates, etc.

Another type of blackout may use virtual grouping where end-clients may be allocated to one or more of these virtual groups and content distribution may be limited to a particular group. Blackouts may also be defined based on IP address ranges. Content distribution may also be controlled by the network service provider (ISP) or broadband operator (BBO). Consequently, blackout may also be defined in terms of the ISP or BBO the end-client belongs to. One of ordinary skill will realize that the aforementioned are simply examples of blackouts, and other type blackouts within the spirit and scope of the present invention may be employed.

Domain

The domainblackout element 210 is provided to target content based on a domain name. In other words, content is accessible only to a specific domain. For instance, a web-based training may be offered only to students of a certain university with an account at the university (e.g., ucsd.edu).

Subscription

The subscription element 212 provides subscription information and controls how content may be offered on a subscription basis. For example, the client 102 subscribes to a service from the content provider 104 for a flat fee and is thereafter entitled to receive any content on that service. A subscription ID may be assigned to the client 102 in order to receive such service. With the number of potential services offered on the Internet 114, a subscription ID may be a combination of a content provider ID, which is unique across the service provider, and a service ID, which is unique only within each content provider. In one exemplary embodiment, the subscription element 212 includes the content provider ID (unless specified as part of the content ID), the service ID and an optional title or description.

Cost

The cost element 214 relates to how content is to be charged. For example, content may be offered under multiple purchase options, such as PPV (pay-per-view), PBT (pay-by-time), subscription, etc. Different purchase options may include additional attributes, such as the time increment period for PBT, maximum number of viewings for PPV, etc. Each purchase option may also include an associated price of the content. For instance, the price is guaranteed until the associated session rights object expires, even if the price of the content changes before the content is requested by the client 102. Price may be tagged with a currency (e.g., ISO 4217). US dollars may be used as the default currency.

Content Rating

The rating element 216 relates to rating of content. For example, each piece of content may be assigned a certain rating level. Clients such as the client 102 may set up in their personal preferences a rating ceiling (maximum rating level allowed), which may be used to block access to content. Generally, there are two locations where rating limits may be enforced: at the client 102 or at caching server 115. Note that these are exemplary options and are not necessarily limiting. For example, a third possible location is that the rating ceiling is enforced by caching server 115 but override is allowed at the site which generates the client selections data. This solution assumes that caching server 115 accesses the client database and verifies the rating ceiling override password. Content rating may be multidimensional similar to today's cable TV, broadcast TV or movie ratings. Both the dimension as well as the level in each dimension may be described by this element.

Packages

The package element 218 relates to the packaging or bundling of content. For example, content may be grouped into packages of related content, such as episodes of one show, NHL games, etc. Packages may be managed similarly to subscriptions. A content provider ID and a package ID is used to identify each package.

Watermark

The watermark element 220 relates to identification and association of client with content. For example, the content provider 104 may require that selected content be identified with a watermark carrying information about the client 102 to whom the content is being distributed. If this rule is enabled, caching server 115 extracts client-specific information from the caching server ticket and embeds it into the content before streaming it. This rule may specify whose information is to be embedded in the content: (1) content owner, (2) content distributor, (3) network provider or (4) the end client.

Security Level

The security level element 222 relates to controlling content access based on security levels associated with clients. For example, some content may be restricted to client devices with a predetermined level of security, e.g., hardware-based security chip, smartcard, etc. For example, a new movie may be streamed to clients with a high level of security in the hardware chip. Another use for this rule is to specify the strength of an encryption algorithm to be used for the requested content. For example, the rule may specify a fixed (known) key algorithm, a specific type of algorithm, etc., or alternatively, no encryption rule may be specified.

Network Provider

Optionally, a network element (not shown) is provided to allow a network provider to manipulate content. For example, content may be restricted by the network provider/operator providing the “last mile” service. Information provided by the network element may be used in conjunction with the blackout element 208. A network provider may be associated with each action, if desired, in the form of an element or an attribute, if different rules apply depending on the end client's network provider. The use of the network element allows the network provider with a higher quality network e.g., a network with a Quality of Service, to price its services accordingly.

Promotions

Optionally, a promotion element (not shown) is provided to allow promotional or marketing activities to be conducted in connection with content. For example, the content provider 104 may support different promotional mechanisms such as coupons, discounts for long-time customers, etc. This element identifies whether promotions are allowed and, if so, what types of promotions. This element may be an attribute of the rules describing the cost of purchasing the content. The content provider 104 may offer discounts for new customers (the length of membership may be included in the authorization data), such as free movies for the first month of service, 50% discount for the first three months of service, etc. Loyal customers could get discounts as well depending on the particular loyalty programs, e.g., “the longer you stay with us, the less you pay,” or “get a free movie every six months.”

Time of Day Constraints

Optionally, a TimeOfDay element (not shown) is also provided. This element relates to controlling price levels of content based on the time of day the content is desired. For example, in order to smooth out network traffic and minimize congestion, content may be offered at a discount price at off-peak hours. In an exemplary embodiment, the client 102 selects the offer which is encoded either in the client selections element or in the content rights element. Caching server 115 records the time of actual use and reports that to a billing system for proper billing.

Other elements may specify how the actual billing for content is executed: (1) by the content provider, (2) by service provider, (3) by the network operator, etc. In an exemplary embodiment, this element is not used when clients request the content but after the purchase has been reported to the billing system.

It should be understood that the content rights element as described above is merely illustrative. Based on the disclosure and teachings provided herein, a person of ordinary skill in the art will know how to include other rules and/or elements into the content rights element in accordance with the present invention.

FIG. 3 is a screen shot illustrating the client selections element for identifying selections made by the client 102 in accordance with one exemplary embodiment of the present invention. Note that the client selections element may identify other attributes as well.

Client Selections

The client selections element 302 represents the choice(s) made by the client 102 for certain content. The client selections element 302 represents a right to consume the content, assuming all content access rules relating to the selected content are satisfied. Generally, the content is consumed within a certain time period, i.e., time limit of a contract. For example, the offered price is good for the next 2 hours. In one exemplary embodiment, the client selections element 302 further includes a number of elements, as will be further described below in FIG. 3.

Validity Period

A validity period element 304 is included in the client selections element 302. Because the session rights object may be analogized to a contract with guaranteed price for the specific content, this object is usually time bound. That is, the session rights object may include an expiration time which is provided by the validity period element 304 after which the object cannot be used to obtain the requested content. In addition, the validity period element 304 may indicate a time period in the future for which the contract is valid. Time values are generally in universal coordinated time (UTC) format.

Purchase Option and Price

A purchase option element 304 is included in the client selections element 302. If the content is offered under multiple purchase options, such as PPV, PBT, subscription, etc., the client 102 may select one of them. In some situations, an option is assigned automatically if the client 102 has a specific subscription service. The client 102 is automatically assigned the subscription option since the content has already been paid for by the monthly fee.

This element 304 may optionally include discounts, coupons and other promotions. For instance, the page, where the client 102 selects the content and the corresponding purchase options, may include a request to provide her/his e-mail address for a 10% discount. This information may be included in this element so that a billing system can apply the discount.

Access Rules Override

An access rule override element 308 is provided. This element 308 allows certain rules for a given client to be overridden. For instance, if the client 102 can authenticate himself with a password, a rating ceiling may be temporarily disabled for the selected piece of content.

One of ordinary skill in the art will realize that other rule elements that are not shown may be included in client selections element 302. For example, a quality/resource restrictions element, a secure session identification and a content identification may be included. The quality/resource restrictions element relates to content delivered in different formats and with different levels of quality (HD vs. SD, compression ratio, bandwidth, etc). Quality could be linked to the security level of the client's device or different cost could be attributed to HD or SD format or to delivery with QoS.

The secure session identification element is a unique identifier that ties all components of a streaming session (or a download session) together, such as encryption keys, access rules, etc.

The content identification element may be used to associate the various elements of the session rights object when the client selections element 302 is not delivered together with the content rights element 202.

In one exemplary aspect of the present invention, the client selections and the content rights are included in a session rights object. As mentioned above, the session rights object is received by the client 102 from the content provider 104. Thereafter, the session rights object is forwarded to caching server 115. One of ordinary skill in the art, however, will realize that client selections and content rights need not be combined in a single session rights object. These elements or components may be separately delivered to caching server 15.

The relationship between content rights and client selections is one-to-many. That is, the content rights for a specific content is created only once, while the client selections are generated for each client. This allows the content rights for a specific content to be delivered to caching server 115 via a route separate from the client selections. Pertinent information can be included in the session rights object to indicate whether the content rights and the client selections are delivered together or separately.

In addition, some rules are not applicable depending on the client selections (e.g., if client obtains content using a subscription, rules about pay-per-view are irrelevant). If the content rights and client selections are separated, certain irrelevant rules may be omitted from the content rights element.

It should be understood that the client selections element as described above is merely illustrative. Based on the disclosure and teachings provided herein, a person of ordinary skill in the art will know how to include other rules and/or elements into the client selections element in accordance with the present invention.

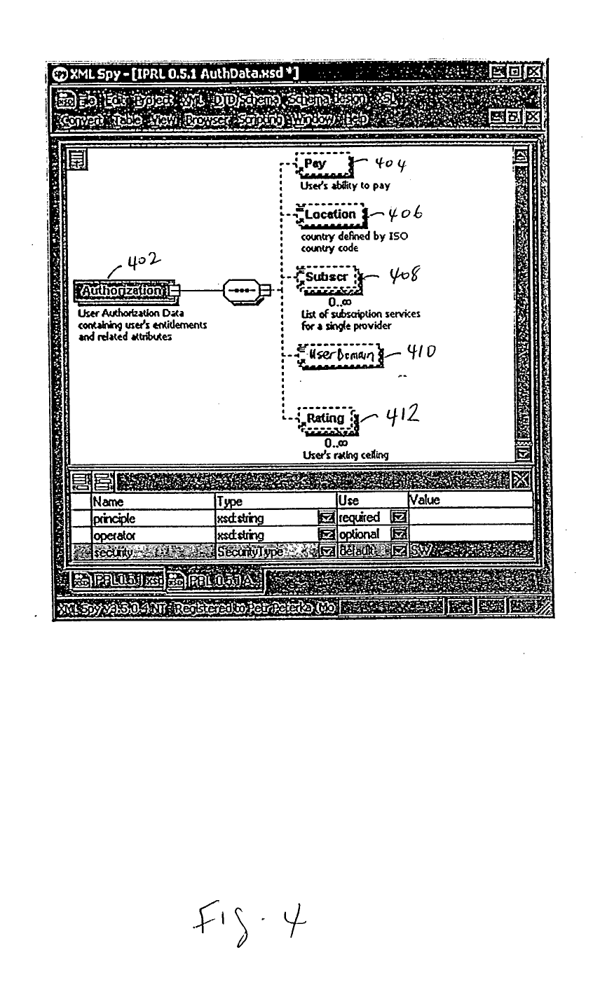

FIG. 4 is a screen shot illustrating an authorization data element 402 in accordance with one exemplary embodiment of the present invention. This element 402 defines the client's entitlement or rights to access and/or use a particular content. Alternatively, this element 402 can be viewed as applying the content rights to the client selections for a specific content.

The client's entitlements include, for example, subscribed services, geographical location, client payment method, and other relevant client data. Each authorization data element 402 is client specific. The authorization data is stored in a client authorization database maintained by the provisioning center 106 or an associated entitlement server (not shown). In one exemplary embodiment, the authorization data element 402 further includes a number elements, as will be further described below in FIG. 4.

Ability to Pay

A pay element 404 relates to the ability of the client 102 to pay for content. This ability may be characterized as, for example, none (i.e., for free content), subscription only (prepaid services), PPV, existing network provider account (e.g., existing cable bill), etc. Information relating to the pay element 404 is typically obtained when the client 102 requests a specific content.

Client Location

A location element 406 describes the geographical location of the client 102. The client location is compared with the geographical blackouts (obtained from the blackout element 208 in the content rights element) to determine whether the client 102 is authorized to receive content. This element may take on different levels of granularity, for example, starting with a country code, ZIP or postal code, all the way down to latitude/longitude or XYZ coordinates.

Subscription List

A subscription element 408 contains a list of all subscribed services and their associated information including, for example, the service provider ID and the service ID. If the client 102 purchases multiple services from the same provider, the provider ID does not have to be repeated with every service. In this case, the provider ID is an attribute of an element containing a list of service IDs belonging to that provider.

User Domain

A user domain element 410 is provided to identify users from a specific domain. Each user may be identified by his/her assigned domain name, such as all students at University of San Diego would have the “ucsd.edu” domain name.

Rating

A rating element 412 is provided to identify the client's rating ceiling for each content.

Other Attributes

It should be understood that the authorization data element as described above is merely illustrative. Based on the disclosure and teachings provided herein, a person of ordinary skill in the art will know how to include other rules and/or elements into the authorization data element in accordance with the present invention. Although not shown, other rule elements may be provided. The following are some examples of such exemplary rule elements, including, (1) length of patronage—this element includes information relating to how long the client 102 has been an active member of a service; this information may be used for certain types of discounts; (2) rating enforcement—this element includes information relating to whether the rating is enforced locally or remotely; for example, content rating may be enforced locally on the client 102 or remotely on caching server 115; (3) network provider assignment—this element includes information relating to how a the client 102 is to be associated with a network provider or broadband operator; for example, a the client 102 may be assigned a primary network provider and such provider may impose additional rules on the content; (4) package list—this element includes information relating to a list of all prepaid packages including the service provider ID and the package ID; (5) virtual grouping—this element includes information relating to client groups; for example, clients may be grouped into virtual groups, such as movie-of-the-month club, senior citizens, etc.; (6) personal settings—this element includes information relating to personal settings specific to the client 102; for example, personal settings may include limits, such as, a rating ceiling for each rating dimension; (7) watermark information—this element includes information associating content and the client 102; (8) device security level—this element includes information relating to security level associated with clients; when clients register as new customers (or update their profile), their respective security levels associated with their devices are determined and stored; (9) client identification—this element includes information relating to the client 102; for example, the information includes a number assigned to the client's account and device when a client is initially provisioned.

Although the structural components of the elements have been described according to IPRL and XML, one of ordinary skill in the art will realize that software instructions based on other programming or computer languages may be employed within the spirit and scope of this invention. In this fashion, the present invention provides a digital rights management system for determining whether a client is authorized to access content in a communication network.

In addition, in some situations, other parties may be involved in the content distribution chain in delivering the requested content from the content provider 104 to the client 102. Such other parties include, for example, a content distributor who distributes the content provided by the content provider 104, a network provider/operator and a service provider, etc. As a result, such other parties may wish to exert some control over the distribution and/or access of the requested content before such content is delivered to the client 102. For example, a service provider may wish to include its own additional rules in connection with the delivery of the requested content to the client 102. Such additional rules may be imposed on top of the rules already defined by the content provider 104. In another example, a service provider may wish to select an associated sub-rule that is provided for in a rule previously defined by the content provider 104, such as, in a situation where the content provider 104 defines a rule setting a price range for a specific content and allowing a service provider to select any price within that price range, and the service provider subsequently defines an associated sub-rule setting a price within that price range. In other words, parties involved in a content distribution chain may each be allowed to provide their respective rules in connection with the requested content.

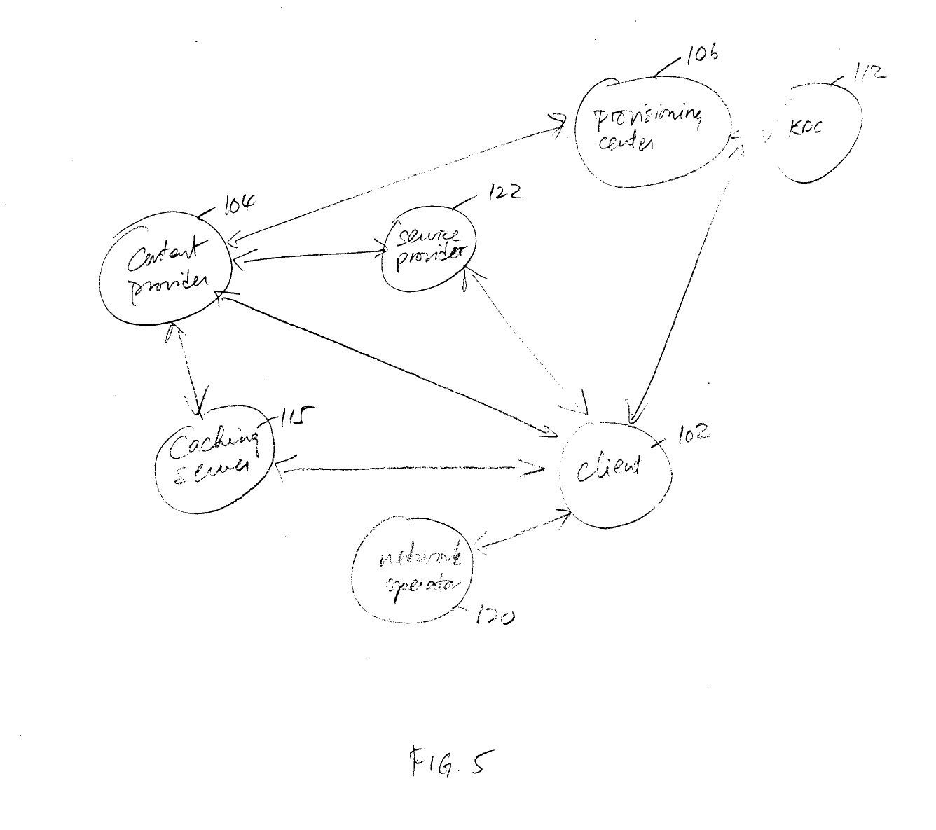

FIG. 5 is a simplified block diagram illustrating another exemplary embodiment of the digital rights management system in accordance with the present invention. As shown in FIG. 5, the client 102 subscribes network services from a network operator 120. The network operator 120 provides the network equipment and associated network services to the client 102 to allow the client 102 to receive the requested content. The network operator 120 has its own additional rules and/or sub-rules that it may wish to impose in connection with the network services that it provides to the client 102. For example, an additional rule may relate to service discounts being offered by the network operator 120. In that regard, the network operator 120 forwards the additional rules and/or sub-rules to the client 102. Optionally, information relating to the additional rules and/or sub-rules may be displayed to the client 102. For example, the client 102 may be informed of price changes incurred as a result of the higher quality of service and bandwidth requirements needed to deliver the requested content. The client 102 retains the additional rules and/or sub-rules from the network operator 120 for subsequent processing.

The client 102 then contacts a service provider 122 to request a particular content, such as, a movie. Upon receiving the request, the service provider 122 examines the request to identify the corresponding content provider 104 which is able to provide the requested content and then redirects the client 102 to contact that content provider 104 to allow the client 102 to request the particular content. The relationship between the service provider 122 and the content provider 104 can be that of a movie distributor and a movie company. The movie distributor has in its inventory a number of movies which are available for viewing. Upon receiving a request for a particular movie from the client 102, the movie distributor redirects the client 102 to contact the movie company that has the requested movie.

In addition to redirecting the client 102 to the content provider 104, the service provider 122 may also optionally forward to the client 102 its own additional rules and/or sub-rules that it may wish to impose in connection with the services that it provides to the client 102. For example, the service provider 122 may offer a loyalty program which rewards the client 102 for past purchases. Similarly, the client 102 retains the additional rules and/or sub-rules from the service provider 122 for subsequent processing.

It should be noted that the additional rules and/or sub-rules to be added by the service provider 122 and the network operator 120 do not necessarily have to be tied to the requested content. Instead, these additional rules and/or sub-rules can be linked to the client 102. For example, the service provider 122 can offer a discount that is tied to the client 102 for any content purchased during a promotion period.

In an exemplary implementation, the additional rules and/or sub-rules can be based on the same schema that is used with the original rules or, alternatively, the additional rules and/or sub-rules can be defined using different schema.

Once the client 102 is in contact with the content provider 104, the client 102 forwards to the content provider 104 information identifying the caching server 115 which is closest to the client 102. In response, the content provider 104 forwards a session rights object relating to the requested content to the client 102, as previously described above. The session rights object can also include sub-rules that are specific to the client 102. Alternatively, the session rights object can be delivered to the client 102 from another party. Optionally, the session rights object delivered by the other party may contain the original rules specified by the content provider 104 as well as any other additional rules and/or sub-rules specified by the other party and additional party(ies). For example, the service provider 122 may obtain the session rights object from the content provider 104, incorporate or concatenate its own additional rules into the session rights object and then deliver the session rights object to the client 102. Additionally, the service provider 122 may also include additional rules from the network operator 120 and incorporate such additional rules into the session rights object as well.

As described above, after the client 102 is authenticated by the KDC 112, the KDC 112 forwards a caching server ticket to the client 102. The caching server ticket contains authorization data that is to be used to complete delivery of the requested content to the client 102, as further described below.

Next, the client 102 forwards the caching server ticket, the session rights object and the respective additional rules and/or sub-rules supplied by the network operator 120 and the service provider 122 to the caching server 115. Optionally, the client 102 may also forward additional details relevant to the transaction to the caching server 115. For example, the client 102 may want to use a discount coupon that it has on the pending transaction. Information relating to the discount coupon can be forwarded to the caching server 115 for use in calculating the purchase price.

In an alternative manner, the respective additional rules and/or sub-rules can be forwarded directly to the caching server 115 from the network operator 120 and the service provider 122. The respective additional rules and/or sub-rules are associated with a content identifier that allows them to be linked to the original rules identified in the session rights object.

In another alternative manner, some or all of the original rules from the content provider 104 and/or the respective additional rules and/or sub-rules from the network operator 120 and the service provider 122 are already stored at the caching server 115. For example, certain access rules relating to a particular content do not vary and hence can be stored at the caching server 115.

It should be noted that these additional rules and/or sub-rules can be added and delivered to the caching server 115 either before or after the client 102 obtains the session rights object.

The caching server 115 then verifies and reconciles all the relevant rules and sub-rules and resolves any conflicts. The relevant rules and/or sub-rules are then validated against the authorization data contained within the caching server ticket. This validation is performed to ensure that the requested content will be delivered in compliance with the rules and/or sub-rules set forth by the content provider 104, the service provider 122 and the network operator 120. If the validation is successful, the caching server 115 delivers the requested content to the client 102.

In one exemplary embodiment, since other parties are able to add rules and/or sub-rules in addition to the rules originally provided in the session rights object, additional logic or mechanism is provided to ensure that such parties are authorized to add their rules and/or sub-rules and that the added rules and/or sub-rules are not in violation of the original rules. In an exemplary implementation, such additional logic or mechanism is included as part of the session rights object. It should also be noted that one sub-rule can further define one or more sub-rules.

Using the situation illustrated in FIG. 5, for example, the content provider 104 sets the original rules associated with a session rights object. The content provider 104 is further able to control and specify what additional rules and/or sub-rules can be added downstream and who can add these additional rules and/or sub-rules. For example, the content provider 104 may provide that the service provider 122 is able to select a price that can be charged for a specific content from a price range that is previously defined in an original rule specified by the content provider 104. In order to allow additional rules and/or sub-rules to be added, the party adding the additional rules and/or sub-rules is identified and authenticated before any newly added rules and/or sub-rules are enforced.

The content provider 104 can control addition of additional rules and/or sub-rules in a number of ways. For example, the content provider 104 can either list a specific set of rules and/or sub-rules that are allowed to be added or allow any rules and/or sub-rules to be added. Moreover, the content provider 104 can also either provide a list of parties who are allowed to add additional rules and/or sub-rules or grant blanket or wildcard permission to any party for that purpose. For each original rule, the content provider 104 can not only specify a list of parties who are allowed to add additional rules and/or sub-rules, the content provider 104 can also specify how each party is to be authenticated. For example, a party can be authenticated using PKI and digital certificates.

In order to keep the original rules and the new rules or sub-rules consistent, additional logic or mechanism is provided to resolve any conflict between an original rule and any new rules or sub-rules. For example, it is predetermined that an original rule is not to be overridden or reversed by any subsequent new rule and/or sub-rule; in other words, the new rule or sub-rule is only allowed to augment the original rule. In another example, any new rule or sub-rule is allowed as along as it is not prohibited by the content provider 104.

Moreover, an original rule that allows additional rules and/or sub-rules to be specified is able to resolve conflict between two or more subsequently specified additional rules and/or sub-rules. For example, the original rule can include a priority attribute that prioritizes the possible parties that can specify the sub-rules under that original rule. The party with the higher priority is able to overrule a party with a lower priority.

Furthermore, to ensure the authenticity of a new rule or sub-rule, each new rule or sub-rule is authenticated using a caching server ticket, as described above. That is, the party attempting to add the new rule or sub-rule is first authenticated by the KDC 112. The KDC 112 then issues the caching server ticket with respect to that party and the new rule or sub-rule. The caching server 115 then receives the caching server ticket and confirms that the new rule or sub-rile to be added are authentic. If the original rule or sub-rule is defined by the content provider 104 in an inclusive way, i.e., specifying that a new rule or sub-rule can be added but not who can add it, then the caching server 115 would record the name of the entity who added the new rule or sub-rule. If the original rule or sub-rule is defined in an exclusive way, i.e., only a specific entity or party can add to the original rule or sub-rule, the caching server 115 would not only authenticate the entity or party but also verify that the entity or party is allowed to add the new rule or sub-rule.

While the above description is given with respect to the content provider 104, it should be understood that the same applies to other parties who are able to set the original rules. Furthermore, a party is able to add one or more rules or sub-rules to a previously added rule or sub-rule. For example, if the network operator 120 and the service provider 122 are collaborating on a joint promotion, the network operator 120 may add a rule to a rule that has just been added by the service provider 122.

In one exemplary implementation, the present invention is implemented with control logic using computer software in either an integrated or modular manner. However, it should be understood that based on the disclosure and teachings provided herein, a person of ordinary skill in the art will know of other ways and/or method to implement the present invention.

While the above is a complete description of exemplary specific embodiments of the invention, additional embodiments are also possible. Thus, the above description should not be taken as limiting the scope of the invention, which is defined by the appended claims along with their full scope of equivalents.

What is claimed is:

1. A system for managing digital rights to a content in a network, comprising:
control logic configured to provide a session rights object to a client requesting the content, the session rights object including a plurality of content access rules relating to the content, the plurality of content access rules created by a first party providing the content; and
control logic configured to allow a second party to add one or more additional rules to the plurality of content access rules;
wherein at least one of the plurality of content access rules specifies whether the second party is allowed to add any additional rules and what types of additional rules are allowed to be added; and
wherein the plurality of content access rules and the one or more additional rules allow the client to access the content.

2. The system of claim 1 further comprising:
control logic configured to reconcile the one or more additional rules with the plurality of content access rules in the event the one or more additional rules conflict with one or more of the plurality of content access rules.

3. The system of claim 1 wherein the first party defines the nature of the one or more additional rules that are to be added by the second party; and
wherein the first party specifies whether the second party is allowed to add the one or more additional rules.

4. The system of claim 1 wherein the first party provides a list of additional rules that are allowed to be added.

5. The system of claim 1 wherein the first party grants blanket permission to allow any additional rules to be added to the plurality of content access rules.

6. The system of claim 1 wherein the first party specifies who will qualify as the second party for purposes of adding the one or more additional rules.

7. The system of claim 1 wherein when reconciling the one or more additional rules with the plurality of content access rules, the plurality of content access rules take priority over the one or more additional rules.

8. The system of claim 1 further comprising:
control logic configured to resolve a conflict between the one or more additional rules.

9. The system of claim 1 wherein an added additional rule is authenticated to determine whether the added additional rule is valid; and
wherein, if appropriate, the second party adding the added additional rule is authenticated and the second party is further verified to determine whether the second party is authorized to add the added additional rule.

10. A system for managing digital rights to a content in a network, comprising:
a content provider configured to provide the content;
a client configured to receive the content;
a first party configured to provide services to allow the client to request the content; and
a caching server configured to receive the content from the content provider and forward the content to the client;
wherein in response to the first party receiving a request by the client for the content, a session rights object is forwarded to the client, the session rights object including a plurality of content access rules, the plurality of content access rules created by the content provider;
wherein the first party is allowed to add one or more first additional rules to the plurality of content access rules;
wherein the session rights object, the one or more first additional rules and the plurality of content access rules are forwarded to the caching server;
wherein the caching server reconciles the one or more first additional rules with the plurality of content access rules and validates the reconciled rules to allow the client to receive the content.

11. The system of claim 10 wherein the one or more first additional rules are concatenated with the plurality of content access rules into the session rights object for delivery to the client which in turn forwards the session rights object with the concatenated one or more first additional rules and the plurality of content access rules to the caching server.

12. The system of claim 10 wherein the session rights object including the plurality of content access rules and the one or more first additional rules are delivered to the client separately; and
wherein the client forwards the session rights object including the plurality of content access rules and the one or more first additional rules to the caching server.

13. The system of claim 10 wherein the session rights object including the plurality of content access rules is delivered to the client which in turn forwards the session rights object to the caching server;
wherein the one or more first additional rules are forwarded by the service provider to the caching server; and
wherein the one or more first additional rules are forwarded by the first party either before or after the client forwards the session rights object to the caching server.

14. The system of claim 10 wherein the first party is a service provider.

15. The system of claim 10 further comprising:
a second party configured to provide services to allow the content to be delivered to the client;
wherein the second party is allowed to add one or more second additional rules to either the plurality of content access rules or the one or more first additional rules.

16. The system of claim 15 wherein the second party is a network operator.

17. The system of claim 15 wherein the caching server is able to reconcile the one or more first additional rules and the one or more second additional rules.

18. The system of claim 17 wherein one or more of the plurality of content access rules provide conflict resolution information to allow the caching server to reconcile the one or more first additional rules and the one or more second additional rules.

19. The system of claim 10 wherein the content provider defines the nature of the one or more first additional rules to be added by the first party; and
wherein the content provider specifies whether the first party is allowed to add the one or more first additional rules.

20. The system of claim 10 wherein the content provider provides a list of the one or more first additional rules that are allowed to be added.

21. The system of claim 10 wherein the content provider grants blanket permission to allow any additional rules to be added to the plurality of content access rules.

22. The system of claim 10 wherein the content provider specifies who will qualify as the first party for purposes of adding the one or more first additional rules.

23. The system of claim 10 wherein when reconciling the one or more first additional rules with the plurality of content access rules, the plurality of content access rules take priority over the one or more first additional rules.

24. The system of claim 10 wherein at least one of the one or more first additional rules is allowed to modify one of the plurality of content access rules.

25. The system of claim 10 wherein an added first additional rule is authenticated to determine whether the added first additional rule is valid; and
wherein, if appropriate, the first party adding the added first additional rule is authenticated and the first party is further verified to determine whether the first party is authorized to add the added first additional rule.

26. A system for managing digital rights to a content in a network, comprising:
control logic configured to provide a session rights object to a client requesting the content, the session rights object including a plurality of content access rules, the plurality of content access rules created by a first party providing the content, wherein at least one of the plurality of content access rules specifies one or more additional rules that are allowed to be added to that corresponding content access rule and one or more parties that are allowed to add the one or more additional rules; and
control logic configured to reconcile one or more added additional rules with the plurality of content access rules and validate the reconciled rules to allow the client to access the content.

27. The system of claim 26 wherein the first party defines the nature of the one or more additional rules that are allowed to be added; and
wherein the first party specifies the one or more parties that are allowed to add the one or more additional rules.

28. The system of claim 26 wherein the first party grants blanket permission to allow any additional rules to be added to the plurality of content access rules.

29. The system of claim 26 wherein the first party specifies who will qualify as the one or more parties that are allowed to add the one or more additional rules.

30. The system of claim 26 wherein when reconciling the one or more added additional rules with the plurality of content access rules, the plurality of content access rules take priority over the one or more added additional rules.

31. The system of claim 26 further comprising:
control logic configured to resolve a conflict between the one or more added additional rules.

32. The system of claim 26 wherein an added additional rule is authenticated to determine whether the added additional rule is valid; and
wherein, if appropriate, a party adding the added additional rule is authenticated and the party is further verified to determine whether the party is authorized to add the added additional rule.
